(19) United States
(12) Patent Application Publication
(10) Pub. No.: US 2021/0256416 A1
(43) Pub. Date: Aug. 19, 2021

(54) TRAINING OF VARIATIONAL QUANTUM CLASSIFIERS BY PARAMETRIC COORDINATE ASCENT

(71) Applicant: Microsoft Technology Licensing, LLC, Redmond, WA (US)

(72) Inventors: Alexei Bocharov, Redmond, WA (US); Martin Roetteler, Woodinville, WA (US)

(73) Assignee: Microsoft Technology Licensing, LLC, Redmond, WA (US)

(21) Appl. No.: 16/790,363

(22) Filed: Feb. 13, 2020

(51) Int. Cl. G06N 20/00; G06N 5/04; G06N 10/00

(52) U.S. Cl. CPC G06N 20/00; G06N 10/00; G06N 5/04

(57) ABSTRACT

Embodiments of the disclosed technology employ parametric coordinate ascent to train a quantum circuit. In certain implementations, parameters (e.g., variational parameters) are learned by coordinate ascent using closed form equations. This strategy helps ensure monotonic convergence to local maxima in parameter space at predictable convergence rates and eliminates the overhead due to hyperparameter sweeps.

### FIELD

This application concerns quantum computing.

### SUMMARY

This disclosure descries embodiments of a quantum classifier training strategy. In some examples, optimal parameters are learned by coordinate ascent using closed-form equations for absolute conditional maximum of the utility function in one parameter at a time. In such examples, this strategy helps ensures monotonic convergence to local maxima in a parameter space at predictable convergence rates and eliminates overhead due to hyperparameter sweeps. Embodiments of of the strategy use asymptotically fewer measurements and post-selection steps than other possible approaches. Embodiments of the described methods are also applicable to circuit compression. Numerical simulations are also disclosed that demonstrate embodiments of the technology.

In certain embodiments, a circuit classifier is trained based on variational quantum circuits. The training can comprise, for example: receiving a set of labeled data; performing a coordinate-vise ascent to learn the circuit classifier for the labeled data, wherein the coordinate-wise ascent is performed on a classical computing device and thereby trains the circuit classifier; and executing the trained circuit classifier on a quantum computer. In some implementations, the circuit classifier has a structure with variational parameters. The circuit classifier can comprise a plurality of single-qubit and/or two-qubit gates that have variational parameters defining unitary action of the circuit on quantum states. In some examples, the training further comprises modifying variational parameters one at a time. In further examples, the training comprises maximizing a utility function by selection of one or more variational parameters. The utility function can, for example, apply a non-degenerate observable that has two different eigenvalues. In some examples, the variational parameters are fixed one by one, according to a predetermined schedule that visits each parameters at least once. In other examples, the variational parameters are fixed one by one, according to a randomized schedule that visits each parameter at least once. In some examples, the training comprises splitting the training data into smaller batches that are used by the utility function to update the variational quantum circuits.

Some example embodiments comprise receiving a batch of training samples, a variational quantum circuit skeleton for learning one or more variational parameters, and a set of initial values for the variational parameters; by a classical computer, generating a classical description of a quantum program to be implemented by a quantum circuit; by the classical computer, training the quantum circuit described by the quantum program using the batch of training samples and incrementally adjusting the variational parameters to improve prediction of a set of test data; and implementing the trained quantum circuit described by the quantum program on a quantum computing device.

In some examples, one or more of the following are received: parameter tolerance bounds, or a bound on a maximum number of iterations to be performed during the training. In some implementations, the training is performed iteratively by computing analytic expressions for expectation values of the training data to increase a probability of correct identification of training labels. In some implementations, the expectation value is inferred by computing overlaps between quantum states. For example, the overlap computation can be performed by a Hadamard test to infer the real and imaginary components of the overlap. In further examples, the training sample is given by a qubit encoding or an amplitude encoding in which data is represented as amplitudes or phases of a state vector of qubits of the quantum circuit.

Another example embodiment is a system, comprising: a quantum computing device; and a classical computing device in communication with the quantum computing device, the classical computing device being programmed to predict a class label using a quantum computer that applies a trained quantum circuit to a representation of the input data, measures the quantum state, and generates a sampled bit for inferring the class label. In certain implementations, the representation of the input data is given by an amplitude encoding of the data or a qubit encoding of the data. In further implementations, the classical computing device is programmed to train the quantum computer to predict a class label using a pre-trained classifier circuit. In further implementations, the coordinate ascent procedure uses hyperparameters. In some implementations, the set of hyperparameters includes one or more of: (a) a depth of the quantum circuit that is being trained; (b) a size of a mini-batch in training the quantum circuit; (c) a maximum number of iterations used for training; (d) a number of random restarts that are applied in the training. In certain implementations, a program run on a classical computer is used for sweeping through feasible values of hyperparameters and and post-selecting quantum circuit(s) with the optimal hyperparameter choices.

Any of the disclosed embodiments can be implemented by one or more computer-readable media storing computer-executable instructions, which when executed by a computer cause the computer to perform any of the disclosed methods. Also disclosed herein are systems for performing embodiments of the disclosed embodiments comprising a classical computer configured to program, control, and/or measure a quantum computing device.

The foregoing and other objects, features, and advantages of the disclosed technology will become more apparent from the following detailed description, which proceeds with reference to the accompanying figures.

### BRIEF DESCRIPTION OF THE FIGURES

FIG. 1 illustrates a generalized example of a suitable classical computing environment in which aspects of the described embodiments can be implemented.

FIG. 2 illustrates an example of a possible network topology (e.g., a client-server network) for implementing a system according to the disclosed technology.

FIG. 3 illustrates another example of a possible network topology (e.g., a distributed computing environment) for implementing a system according to the disclosed technology.

FIG. 4 illustrates an exemplary system for implementing the disclosed technology in which the system includes one or more classical computers in communication with a quantum computing device.

FIG. 5 illustrates an example variational circuit in five qubits.

FIG. 6 illustrates an example subalgorithm for coordinate ascent from an initial parameter setting.

FIG. 7 illustrates an example subalgorithm for improvement along an individual parameter.

FIGS. 8-10 are flow charts showing example methods for performing embodiments of the disclosed technology.

### DETAILED DESCRIPTION

### I. General Considerations

As used in this application, the singular forms “a,” “an,” and “the” include the plural forms unless the context clearly dictates otherwise. Additionally, the term “includes” means “comprises.” Further, the term “coupled” does not exclude the presence of intermediate elements between the coupled items. Further as used herein, the term “and/or” means any one item or combination of any items in the phrase.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

### II. Example Computing Environments

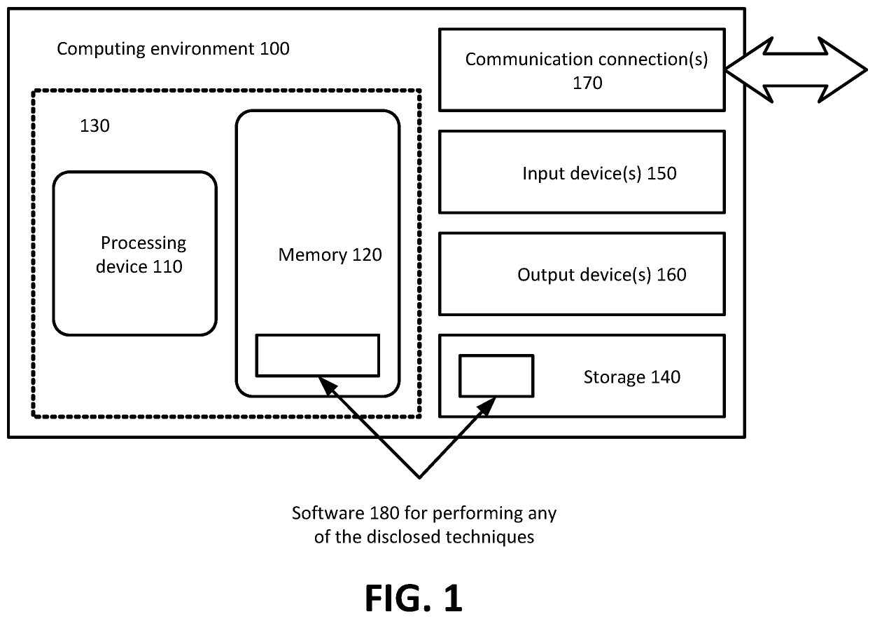

FIG. 1 illustrates a generalized example of a suitable classical computing environment 100 in which aspects of the described embodiments can be implemented. The computing environment 100 is not intended to suggest any limitation as to the scope of use or functionality of the disclosed technology, as the techniques and tools described herein can be implemented in diverse general-purpose or special-purpose environments that have computing hardware.

With reference to FIG. 1, the computing environment 100 includes at least one processing device 110 and memory 120. In FIG. 1, this most basic configuration 130 is included within a dashed line. The processing device 110 (e.g., a CPU or microprocessor) executes computer-executable instructions. In a multi-processing system, multiple processing devices execute computer-executable instructions to increase processing power. The memory 120 may be volatile memory (e.g., registers, cache, RAM, DRAM, SRAM), non-volatile memory (e.g., ROM, EEPROM, flash memory), or some combination of the two. The memory 120 stores software 180 implementing tools for performing any of the disclosed techniques for operating a quantum computer as described herein. The memory 120 can also store software 180 for synthesizing, generating, or compiling quantum circuits for performing any of the disclosed techniques.

The computing environment can have additional features. For example, the computing environment 100 includes storage 140, one or more input devices 150, one or more output devices 160, and one or more communication connections 170. An interconnection mechanism (not shown), such as a bus, controller, or network, interconnects the components of the computing environment 100. Typically, operating system software (not shown) provides an operating environment for other software executing in the computing environment 100, and coordinates activities of the components of the computing environment 100.

The storage 140 can be removable or non-removable, and includes one or more magnetic disks (e.g., hard drives), solid state drives (e.g., flash drives), magnetic tapes or cassettes, CD-ROMs, DVDs, or any other tangible non-volatile storage medium which can be used to store information and which can be accessed within the computing environment 100. The storage 140 can also store instructions for the software 180 implementing any of the disclosed techniques. The storage 140 can also store instructions for the software 180 for generating and/or synthesizing any of the described techniques, systems, or quantum circuits.

The input device(s) 150 can be a touch input device such as a keyboard, touchscreen, mouse, pen, trackball, a voice input device, a scanning device, or another device that provides input to the computing environment 100. The output device(s) 160 can be a display device (e.g., a computer monitor, laptop display, smartphone display, tablet display, netbook display, or touchscreen), printer, speaker, or another device that provides output from the computing environment 100.

The communication connection(s) 170 enable communication over a communication medium to another computing entity. The communication medium conveys information such as computer-executable instructions or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

As noted, the various methods and techniques for performing any of the disclosed technologies, for controlling a quantum computing device, to perform circuit design or compilation/synthesis as disclosed herein can be described in the general context of computer-readable instructions stored on one or more computer-readable media. Computer-readable media are any available media (e.g., memory or storage device) that can be accessed within or by a computing environment. Computer-readable media include tangible computer-readable memory or storage devices, such as memory 120 and/or storage 140, and do not include propagating carrier waves or signals per se (tangible computer-readable memory or storage devices do not include propagating carrier waves or signals per se).

Various embodiments of the methods disclosed herein can also be described in the general context of computer-executable instructions (such as those included in program modules) being executed in a computing environment by a processor. Generally, program modules include routines, programs, libraries, objects, classes, components, data structures, and so on, that perform particular tasks or implement particular abstract data types. The functionality of the program modules may be combined or split between program modules as desired in various embodiments. Computer-executable instructions for program modules may be executed within a local or distributed computing environment.

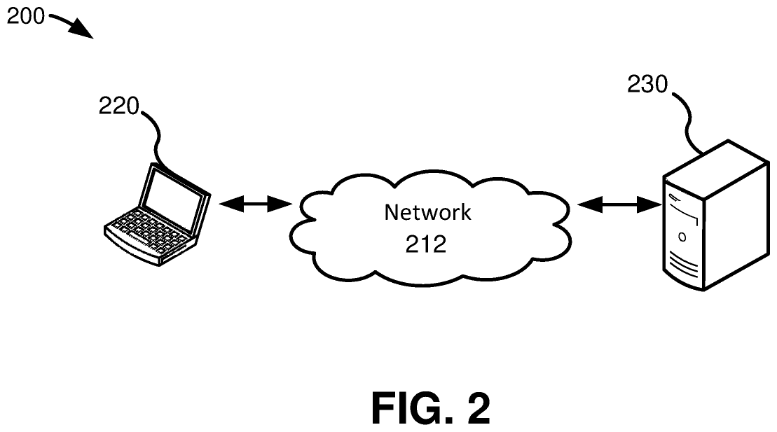

An example of a possible network topology 200 (e.g., a client-server network) for implementing a system according to the disclosed technology is depicted in FIG. 2. Networked computing device 220 can be, for example, a computer running a browser or other software connected to a network 212. The computing device 220 can have a computer architecture as shown in FIG. 1 and discussed above. The computing device 220 is not limited to a traditional personal computer but can comprise other computing hardware configured to connect to and communicate with a network 212 (e.g., smart phones, laptop computers, tablet computers or other mobile computing devices, servers, network devices, dedicated devices, and the like). Further, the computing device 220 can comprise an FPGA or other programmable logic device. In the illustrated embodiment, the computing device 220 is configured to communicate with a computing device 230 (e.g., a remote server, such as a server in a cloud computing environment) via a network 212. In the illustrated embodiment, the computing device 220 is configured to transmit input data to the computing device 230, and the computing device 230 is configured to implement a technique for controlling a quantum computing device to perform any of the disclosed embodiments and/or a circuit generation/compilation/synthesis technique for generating quantum circuits for performing any of the techniques disclosed herein. The computing device 230 can output results to the computing device 220. Any of the data received from the computing device 230 can be stored or displayed on the computing device 220 (e.g., displayed as data on a graphical user interface or web page at the computing devices 220). In the illustrated embodiment, the illustrated network 212 can be implemented as a Local Area Network (“LAN”) using wired networking (e.g., the Ethernet IEEE standard 802.3 or other appropriate standard) or wireless networking (e.g. one of the IEEE standards 802.11a, 802.11b, 802.11g, or 802.11n or other appropriate standard). Alternatively, at least part of the network 212 can be the Internet or a similar public network and operate using an appropriate protocol (e.g., the HTTP protocol).

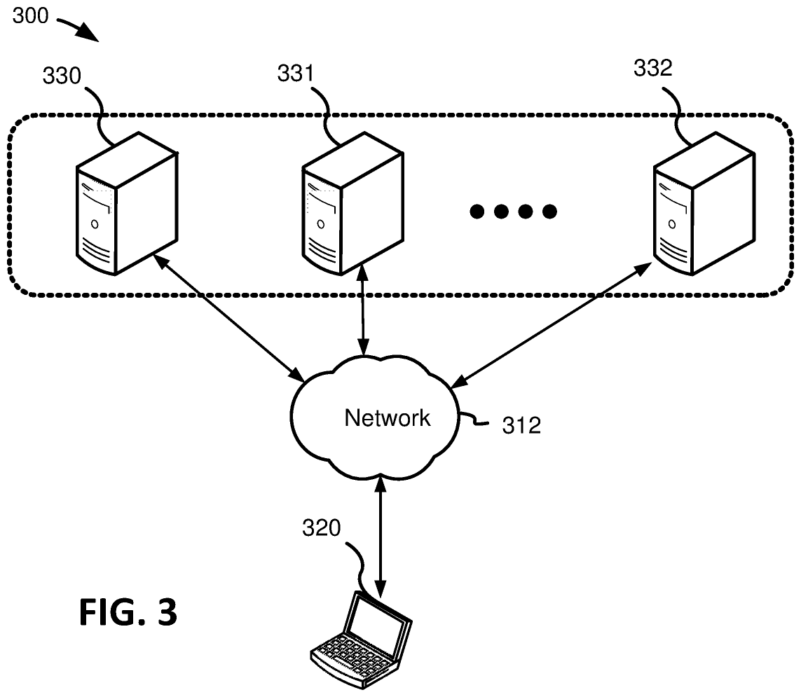

Another example of a possible network topology 300 (e.g., a distributed computing environment) for implementing a system according to the disclosed technology is depicted in FIG. 3. Networked computing device 320 can be, for example, a computer running a browser or other software connected to a network 312. The computing device 320 can have a computer architecture as shown in FIG. 1 and discussed above. In the illustrated embodiment, the computing device 320 is configured to communicate with multiple computing devices 330, 331, 332 (e.g., remote servers or other distributed computing devices, such as one or more servers in a cloud computing environment) via the network 312. In the illustrated embodiment, each of the computing devices 330, 331, 332 in the computing environment 300 is used to perform at least a portion of the disclosed technology and/or at least a portion of the technique for controlling a quantum computing device to perform any of the disclosed embodiments and/or a circuit generation/compilation/synthesis technique for generating quantum circuits for performing any of the techniques disclosed herein. In other words, the computing devices 330, 331, 332 form a distributed computing environment in which aspects of the techniques For performing any of the techniques as disclosed herein and/or quantum circuit generation/compilation/synthesis processes arc shared across multiple computing devices. The computing device 320 is configured to transmit input data to the computing devices 330, 331, 332, which are configured to distributively implement such as process, including performance of any of the disclosed methods or creation of any of the disclosed circuits, and to provide results to the computing device 320. Any of the data received from the computing devices 330, 331, 332 can be stored or displayed on the computing device 320 (e.g., displayed as data on a graphical user interface or web page at the computing devices 320). The illustrated network 312 can be any of the networks discussed above with respect to FIG. 2.

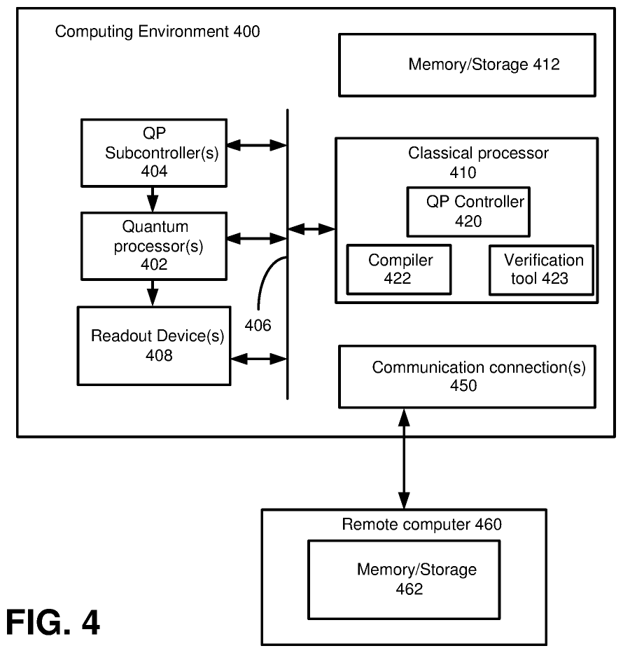

With reference to FIG. 4, an exemplary system for implementing the disclosed technology includes computing environment 400. In computing environment 400, a compiled quantum computer circuit description (including quantum circuits for performing any of the disclosed techniques as disclosed herein) can be used to program (or configure) one or more quantum processing units such that the quantum processing unit(s) implement the circuit described by the quantum computer circuit description.

The environment 400 includes one or more quantum processing units 402 and one or more readout device(s) 408. The quantum processing unit(s) execute quantum circuits that are precompiled and described by the quantum computer circuit description. The quantum processing unit(s) can be one or more of, but are not limited to: (a) a superconducting quantum computer; (b) an ion trap quantum computer; (c) a fault-tolerant architect ire for quantum computing; and/or (d) a topological quantum architecture (e.g., a topological quantum computing device using Majorana zero modes). The precompiled quantum circuits, including any of the disclosed circuits, can be sent into (or otherwise applied to) the quantum processing unit(s) via control lines 406 at the control of quantum processor controller 420. The quantum processor controller (QP controller) 420 can operate in conjunction with a classical processor 410 (e.g., having an architecture as described above with respect to FIG. 1) to implement the desired quantum computing process. In the illustrated example, the QP controller 420 further implements the desired quantum computing process via one or more QP subcontrollers 404 that are specially adapted to control a corresponding one of the quantum processor(s) 402. For instance, in one example, the quantum controller 420 facilitates implementation of the compiled quantum circuit by sending instructions to one or more memories lower-temperature memories), which then pass the instructions to low-temperature control unit(s) (e.g., QP subcontroller(s) 404) that transmit, for instance, pulse sequences representing the gates to the quantum processing unit(s) 402 for implementation. In other examples, the QP controller(s) 420 and QP subcontroller(s) 404 operate to provide appropriate magnetic fields, encoded operations, or other such control signals to the quantum processor(s) to implement the operations of the compiled quantum computer circuit description. The quantum controller(s) can further interact with readout devices 408 to help control and implement the desired quantum computing process (e.g., by reading or measuring out data results from the quantum processing units once available, etc.)

With reference to FIG. 4, compilation is the process of translating a high-level description of a quantum algorithm into a quantum computer circuit description comprising a sequence of quantum operations or gates, which can include the circuits as disclosed herein (e.g., the circuits configured to perform one or more of the procedures as disclosed herein). The compilation can be performed by a compiler 422 using a classical processor 410 (e.g., as shown in FIG. 4) of the environment 400 which loads the high-level description from memory or storage devices 412 and stores the resulting quantum computer circuit description in the memory or storage devices 412.

In other embodiments, compilation and/or verification can be performed remotely by a remote computer 460 (e.g., a computer having a computing environment as described above with respect to FIG. 1) which stores the resulting quantum computer circuit description in one or more memory or storage devices 462 and transmits the quantum computer circuit description to the computing environment 400 for implementation in the quantum processing unit(s) 402. Still further, the remote computer 400 can store the high-level description in the memory or storage devices 462 and transmit the high-level description to the computing environment 400 for compilation and use with the quantum processor(s). In any of these scenarios, results from the computation performed by the quantum processor(s) can be communicated to the remote computer after and/or during the computation process. Still further, the remote computer can communicate with the QP controller(s) 420 such that the quantum computing process (including any compilation, verification, and QP control procedures) can be remotely controlled by the remote computer 460. In general, the remote computer 460 communicates with the QP controller(s) 420, compiler/synthesizer 422, and/or verification tool 423 via communication connections 450. In particular embodiments, the environment 400 can be a cloud computing environment, which provides the quantum processing resources of the environment 400 to one or more remote computers (such as remote computer 460) over a suitable network (which can include the internet).

### III. Training of Variational Quantum Classifiers by Parametric Coordinate Ascent

### A. Introduction to the Disclosed Technology and Preliminaries

Variational quantum circuits (VQC) is a rapidly developing technology crucial for many machine learning applications. The technology is especially desirable for solutions involving noisy intermediate-scale quantum devices. In this disclosure, embodiments that greatly and substantially simplify and streamline the design of variational quantum circuits for classification are disclosed. These embodiments allow for the closed-form analysis of partial derivatives of a given variational circuit with respect to any chosen parameter.

In more detail, and in comparison to other approaches, embodiments of the disclosed technology: (1) asymptotically reduce the number of training epochs used; (2) within each epoch, asymptotically reduce the number of queries to a quantum coprocessor used; (3) provide for a robust monotonic convergence to a local optima; and/or (4) asymptotically reduce the number of destructive measurements used.

In embodiments of the disclosed technology, simplified variational quantum circuits refer to a composition of generalized rotations R(θ, P)=e^{-iθP} or generalized controlled rotation CR(θ, P, Π)=(Π^{⊥}+Πe^{-iθP}), where Π is a projector, Π^{⊥} is its orthogonal complement (Π²=Π, Π+Π^{⊥}=I), and the P and Π form a commuting pair: [P,Π]=0. The uncontrolled generalized rotation is a special case of the controlled one; R(θ, P)=CR(θ, P, I). It is also noted that the customary option of “controlled” is also a special case, where Π projects onto a certain half-space spanned by a half of the standard computational basis.

Remark 1. The commutativity requirement [P, Π]=0 in the above definition of CR(θ, P, Π) is adopted for convenience only. In the absence of commutativity, one can define CR as CR(θ, P, Π)=(Π^{⊥}+Πe^{-iθP}Π) which defines a unitary operator in this more general case. Since this would lead to somewhat more intricate mathematics in the ongoing sections, one can adopt the commutativity requirement. It is satisfied in all further scenarios of interest.

In this example description of the coordinate ascent circuit strategy, one can start with the problem of approximating a target unitary operator and then proceed to develop a flavor of the strategy that trains variational quantum classifier circuits. The training of variational quantum classifiers is a desirable goal.

In both undergoing sections and further in this disclosure, the following ansatz for a variational quantum circuit U([θ], [P], [Π]) is used:

$$U ( [ θ ] , [ P ] , [ Π ] ) = {\prod }_{j = 1}^{L} C R ( {θ}_{j} , {P}_{j} , {Π}_{j} ) \qquad ( 1 )$$

where for each j∈[L], θⱼ is a real valued parameter, Pⱼ²=I and Πⱼ²=Πⱼ.

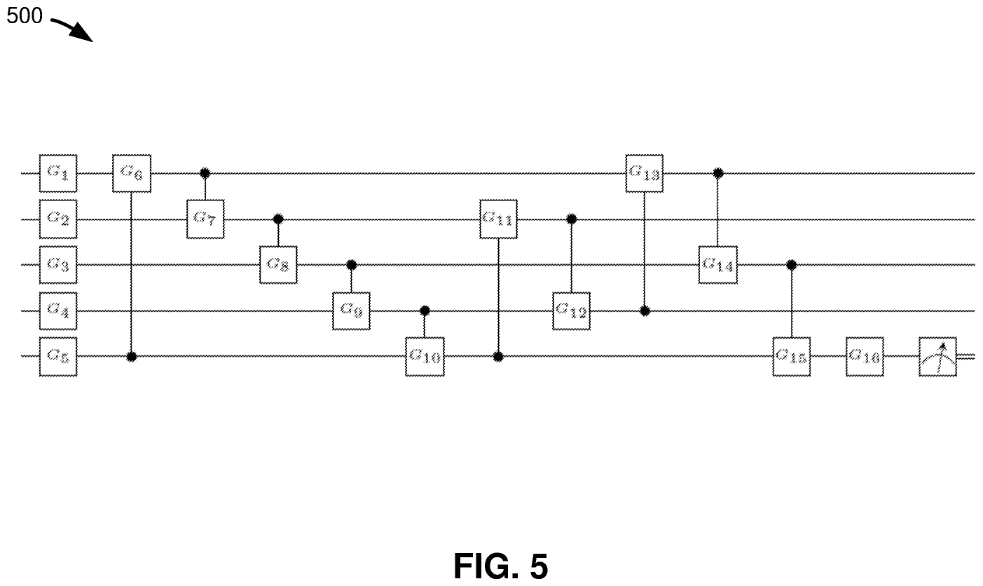

A typical example of a rapidly-entangling variational quantum circuit, in five qubits is shown in FIG. 5. In particular, FIG. 5 shows an example variational circuit in five qubits. The circuit illustrated in FIG. 5 comprises 6 single-qubit gates (G₁, . . . , G₅; G₁₆) and 10 singly-controlled gates forming two “cyclic blocks”. For example, the leftmost two-qubit gate C₅₁ (G₆) can be represented as Π₆^{⊥}+Π₆G₆, where Π₆=½I⁴⊗(I−Z). In this example, P₆ connotes with G₆, because they act on different qubits.

### B. Ancilla-Free Operator Approximation by a Variational Quantum Circuit

In this subsection:

Let [symbol] be a finite set of data samples, where each sample χ∈ [symbol] comes with efficient encoding into a vector of |χ [symbol] of some Hilbert space [symbol] that is common to all the data, samples.

Let A be a unitary operator on the Hilbert space [symbol] and the goal is to approximate the action of operator A on the ensemble of the encoded data samples from [symbol] .

To do this, one can pick a sufficiently large L and look for a circuit of the form (1) (where all Pⱼ, Πⱼ operate on [symbol] ) that optimally emulates the action of A on [symbol] .

One can define the optimal circuit as a circuit that maximizes (or otherwise improves) the following utility function:

$$ℒ ( [ θ ] , [ P ] , [ Π ] ) = \frac{1}{\vert 𝒟 \vert} {\sum }_{x ϵ𝒟} 〈 U ( [ θ ] , [ P ] , [ Π ] ) x \vert Ax 〉 . \qquad ( 2 )$$

This utility function has the upper bound of 1, which is reached if and only if the circuit U([θ], [P], [Π]) provide precise emulation of A on the set [symbol] . Otherwise it, measures the mean cosine similarity between images of data samples under the action of U([θ], [P], [Π]) and A respectively.

For a chosen j∈[L], one can split the variational circuit (1) into

$$U ( [ θ ] , [ P ] , [ Π ] ) = {V}_{j} C R ( {θ}_{j} , {P}_{j} , {Π}_{j} ) {W}_{j} \\ where \\ {V}_{j} = {V}_{j} ( [ θ ] , [ P ] , [ Π ] ) = {\prod }_{k = 1}^{j - 1} C R ( {θ}_{k} , {P}_{k} , {Π}_{k} ) ; \\ {W}_{j} = {W}_{j} ( [ θ ] , [ P ] , [ Π ] ) = {\prod }_{k = j + 1}^{L} C R ( {θ}_{k} , {P}_{k} , {Π}_{k} ) ; \qquad ( 3 )$$

and where one can explicitly use the representation

CR(θⱼ,Pⱼ,Πⱼ)=Πⱼ^{⊥}+Πⱼ(cos(θⱼ)I−i sin(θⱼ)Pⱼ). (4)

By usual convention, a product expression (as shown above) defaults to an identity operator when the number of factors is less than one.

The dependence of [symbol] ([θ], [P], [Π]) on θⱼ can now be explicitly written out as:

$$ℒ ( [ θ ] , [ P ] , [ Π ] ) = {A}_{j} ( {θ}_{∼ j} ) + {B}_{j} ( {θ}_{∼ j} ) cos ( {θ}_{j} ) + {C}_{j} ( ( {θ}_{∼ j} ) sin ( {θ}_{j} ) , \\ where \text{:} \\ {A}_{j} ( {θ}_{∼ j} ) = \frac{1}{\vert 𝒟 \vert} {\sum }_{x ϵ𝒟}^{ } 〈 {V}_{j} {Π}_{j}^{⊥} {W}_{j} x \vert Ax 〉 , \\ {B}_{j} ( {θ}_{∼ j} ) = \frac{1}{\vert 𝒟 \vert} {\sum }_{x ϵ𝒟}^{ } 〈 {V}_{j} {Π}_{j} {W}_{j} x \vert Ax 〉 , \\ {C}_{j} ( {θ}_{∼ j} ) = \frac{1}{\vert 𝒟 \vert} {\sum }_{x ϵ𝒟}^{ } 〈 {V}_{j} {Π}_{j} {P}_{j} {W}_{j} x \vert Ax 〉 . \qquad ( 5 )$$

Here, θ_{˜j} is introduced to denote the “punctured” list of parameters, in particular θ_{˜j}=[θ₁, . . . , θⱼ₋₁, θⱼ₊₁, . . . , θ_{L}].

It follows that:

$$\frac{\partial ℒ ( [ θ ] , [ P ] , [ Π ] )}{\partial {θ}_{j}} = - {B}_{j} ( {θ}_{∼ j} ) sin ( {θ}_{∼ j} ) + {C}_{j} ( ( {θ}_{∼ j} ) cos ( {θ}_{j} ) . \qquad ( 6 )$$

Since each of the angles θⱼ span the compact smooth circumference S¹, the θ*ⱼ=argmax₀_{ⱼ}( [symbol] ([θ], [P], [Π])|θ_{˜j}) is one of its interior significant points. In other words, one has

tan(θ*ⱼ)=Cⱼ(θ_{˜j})/Bⱼ(θ_{˜j}).

Thus, for any choice of fixed values in θ_{˜j}, one can compute the conditional maximum of the utility function in θⱼ (given these values) in closed form. This eliminates problems related to a bad choice of learning rates, problems with vanishing stochastic gradients, and/or, more generally, problems with slow or unstable convergence of stochastic gradient ascent.

### C. Locally Optimal Variational Classifier Circuit

Consider now a mathematical description of a variational quantum classifier. Such a classifier strives to learn an optimal observable such that the expected value of that observable on a data sample predicts the class label to be assigned to that sample.

Let A be some standard observable—for example, a Pauli operator—on [symbol] expressed in computational basis and let U([θ])=U([θ], [P], [Π]) be a variational circuit of the form (1). For quantum encoding |χ [symbol] of an input data sample, one can look to use

[symbol]

U([θ]), [P], [Π])χ|A|U([θ], [P], [Π])χ [symbol] ,

as the inference expectation.

For simplicity, it is assumed here and below, that the observable A is non-degenerate and has two eigenvalues λ₁, λ₂∈ [symbol] . Suppose, without loss loss of generality, that λ₁>λ₂.

Let [symbol] be a finite set of data samples, and [symbol] : [symbol] ∴{λ₁, λ₂} be a two-level labeling function.

By spectral theorem,

A=λ₁Π_{λ}_{₁}+λ₂Π_{λ}_{₂},

where Π_{λ}_{ⱼ}, j=1, 2 is the orthogonal projector on the corresponding eigenspace of A, Π_{λ}_{₁}+Π_{λ}_{₂}= [symbol] .

Note that, because λ₁>λ₂ one can rewrite the two projectors as:

$${Π}_{λ1} = \frac{1}{{λ}_{1} - {λ}_{2}} ( A - {λ}_{2} ) , \\ {Π}_{λ2} = \frac{1}{{λ}_{1} - {λ}_{2}} ( {λ}_{1} - A ) .$$

One can infer the class label of an input data sample χ based on the overlap of its quantum encoding |χ [symbol] with either of the two eigenspaces of the observable U([θ])^{†}AU([θ]).

The mean probability of inferring the right label by this method can be expressed as:

$$\frac{1}{\vert 𝒟 \vert} {\sum }_{x ϵ 𝒟} 〈 x \vert {U ( [ θ ] )}^{†} {Π}_{ℓ ( x )} U ( [ θ ] ) \vert x 〉 . \qquad ( 7 )$$

Using the above formulae for projectors this cam be rewritten as:

$$\frac{1}{{λ}_{1} - {λ}_{2}} ℒ ( [ θ ] , [ P ] , [ Π ] ) + constant \\ where \text{:} \\ ℒ ( [ θ ] , [ P ] , [ Π ] ) = \frac{1}{\vert 𝒟 \vert} ( {\sum }_{ℓ ( x ) = {λ}_{1}} 〈 x \vert {U ( [ θ ] )}^{†} AU ( [ θ ] ) \vert x 〉 - {\sum }_{ℓ ( x ) = {λ}_{2}} 〈 x \vert {U ( [ θ ] )}^{†} AU ( [ θ ] ) \vert x 〉 ) \qquad ( 8 )$$

is what is going to be used as the classifier utility function. Again, because the angle parameters [θ] span a smooth compact manifold, the utility function [symbol] ([θ], [P], [Π]) desirably reaches a maximum at one of its interior critical points of the parameter space.

For a chosen j∈[L], fix all the parameters in θ_{˜j}=(θ₁, . . . , θⱼ₋₁, θⱼ₊₁, . . . , θ_{L}). In order to find conditional maximum max_{θ}_{ⱼ} ( [symbol] ([θ], [P], [Π])|θ_{˜j}) an estimate of the derivative is desirable:

$$\frac{\partial ℒ ( [ θ ] , [ P ] , [ Π ] )}{\partial {θ}_{j}} .$$

Recall the split:

U([θ], [P], [Π])=VⱼCR(θⱼ, Pⱼ, Πⱼ)Wⱼ.

In view of explicit representation (4), one can rewrite each term of equation (8) as follows:

[symbol]

[symbol]

χ|U([θ])^{†}AU([θ])|χ [symbol] = [symbol] [symbol] Vⱼ(Πⱼ^{⊥}+Πⱼ(cos(θⱼ)I−i sin(θⱼ)Pⱼ))Wⱼχ|A|Vⱼ(Πⱼ^{⊥}+Πⱼ(cos(θⱼ)I−i sin(θⱼ)Pⱼ))Wⱼχ

[symbol]

and

aⱼ(θ_{˜j},χ)+bⱼ(θ_{˜j},χ)cos(θⱼ)+cⱼ((θ_{˜j},χ)sin(θⱼ)+dⱼ(θ_{˜j},χ)cos²(θⱼ)+eⱼ(θ_{˜j},χ)sin(θⱼ)cos(θⱼ)+fⱼ(θ_{˜j},χ)sin²(θⱼ)

where:

aⱼ(θ_{˜j},χ)= [symbol] (VⱼΠⱼ^{⊥}Wⱼχ|A|VⱼΠⱼ^{⊥}Wⱼχ [symbol] ,

bⱼ(θ_{˜j},χ)=2 [symbol] (Vⱼ,Πⱼ^{⊥}Wⱼχ|A|VⱼΠⱼWⱼχ [symbol] ,

cⱼ(θ_{˜j},χ)=2ℑ(VⱼΠⱼPⱼWⱼχ|A|VⱼΠⱼ^{⊥}Wⱼχ [symbol] ,

dⱼ(θ_{˜j},χ)= [symbol] (VⱼΠⱼWⱼχ|A|VⱼΠⱼWⱼχ [symbol] ,

eⱼ(θ_{˜j},χ)=2ℑ [symbol] VⱼΠⱼPⱼWⱼχ|A|VⱼΠⱼWⱼχ

[symbol]

fⱼ(θ_{˜j},χ)= [symbol] [symbol] VᵢΠⱼPⱼWⱼχ|A|VⱼΠⱼPⱼWⱼχ [symbol] .

### Hence,

$$\frac{ℒ ( [ θ ] , [ P ] , [ Π ] )}{\partial {θ}_{j}} = - {B}_{j} ( {θ}_{∼ j} ) sin ( {θ}_{j} ) + {C}_{j} ( {θ}_{∼ j} ) cos ( {θ}_{j} ) + 2 ( {F}_{j} ( {θ}_{∼ j} ) - {D}_{j} ( {θ}_{∼ j} ) ) sin ( {θ}_{j} ) cos ( {θ}_{j} ) + {E}_{j} ( {θ}_{∼ j} ) ( {cos}^{2} ( {θ}_{j} ) - {sin}^{2} ( {θ}_{j} ) )$$

where, for each (S, s)∈{(B, b), (C, c), (D, d), (E, e), (F, f)}:

$${S}_{j} ( {θ}_{∼ j} ) = \frac{1}{\vert 𝒟 \vert} ( {\sum }_{ℓ ( x ) = {λ}_{1}} {s}_{j} ( {θ}_{∼ j} , x ) - {\sum }_{ℓ ( x ) = {λ}_{2}} {s}_{j} ( {θ}_{∼ j} , x ) ) .$$

In order to obtain closed-form solutions at the critical points, where

$$\frac{\partial ℒ ( [ θ ] , [ P ] , [ Π ] )}{\partial {θ}_{j}} = 0 \qquad ( 9 )$$

one can introduce the intermediate variable t=tan(θⱼ/2) and, by direct manipulation find that (9) is equivalent to

(Eⱼ(θ_{˜j})−Cⱼ(θ_{˜j}))t⁴−2(Bⱼ(θ_{˜j})−2Dⱼ(θ_{˜j})+2Fⱼ(θ_{˜j}))t³−6Eⱼ(θ_{˜j})t²− (10)

2(Bⱼ(θ_{˜j})+2Dⱼ(θ_{˜j})−2Fⱼ(θ_{˜j}))t+(Eⱼ(θ_{˜j})+Cⱼ(θ_{˜j}))=0 (11)

Therefore, in certain cases, there are at most four candidate values for conditional argmax of [symbol] ([θ], [P], [Π]) that can be inspected in a purely classical loop once the coefficients in (9) are collected. In principle, these candidates could be written out in closed form using Ferrari or Euler formulae). However, note that, in certain embodiments, the focus is on real roots of the quartic in t, and note also that the coefficients of that quartic are typically noisy—therefore an approximate search for real only roots is well-justified.

When j-th factor of U(θ) is an uncontrolled unitary, e.g. Πⱼ= [symbol] , Πⱼ^{⊥}=0, then the (9) collapses into a much simpler equation that has been discussed, for instance, in M. Ostaszewski and E. Grant and M. Benedetti, “Quantum circuit structure learning,” (2019), ArXiv 1905.09692.

### 1. Remark on Projectors and Expectations

In the definition of generalized controlled rotation CR(θ, P, Π)=(Π^{⊥}+Πe^{-iθP}) above, a general notion of a projector is allowed. To make the preceding computations constructive, however, it is desirable to bind the projector with a unitary operator that is efficiently computed.

For example, suppose G is some easy to compute unitary gate with two eigenvalues μ₁, μ₂, and

G=μ₁Π₁+μ₂Π₂

is the spectral decomposition of G (with Π₁, Π₂ being the projectors onto the corresponding eigenspaces).

Then

$$Π = {Π}_{2} = \frac{1}{{μ}_{1} - {μ}_{2}} ( {μ}_{1} - G ) ;$$

$${Π}^{⊥} = {Π}_{1} = \frac{1}{{μ}_{1} - {μ}_{2}} ( G - {μ}_{2} ) .$$

Under this assumption, any overlap involving projectors can be computed as a linear combination of purely unitary expectations. For example, in the above derivation

$${d}_{j} ( {θ}_{∼ j} , x ) = 〈 {V}_{j} Π {W}_{j} x \vert A \vert {V}_{j} Π {W}_{j} x 〉 = \frac{1}{{μ}_{1} - {μ}_{2}} ( {\vert {μ}_{1} \vert}^{2} 〈 {V}_{j} {W}_{j} x \vert A \vert {V}_{j} {W}_{j} x 〉 + 〈 {V}_{j} {GW}_{j} x \vert A \vert {V}_{j} {GW}_{j} x 〉 - 2 ( {μ}_{1} 〈 {V}_{j} {W}_{j} x \vert A \vert {V}_{j} {GW}_{j} x 〉 )$$

In particular, a one-qubit control on the qubit number c can be written up with G_{c}=I⊗ . . . ⊗Z_{c}⊗ . . . ⊗I that has eigenvalues μ₁=1, μ₂=−1. Here for Π=Π₂, has:

$${d}_{j} ( {θ}_{∼ j} , x ) = 〈 {V}_{j} Π {W}_{j} x \vert A \vert {V}_{j} Π {W}_{j} x 〉 = \\ \frac{1}{4} ( 〈 {V}_{j} {W}_{j} x \vert A \vert {V}_{j} {W}_{j} x 〉 {+}_{j} {G}_{c} {W}_{j} x \vert A \vert {V}_{j} {G}_{c} {W}_{j} x 〉 - 2 ( 〈 {V}_{j} {W}_{j} x \vert A \vert {V}_{j} {G}_{c} {W}_{j} x 〉 )$$

Similarly, if one wants projectors Π, Π^{⊥} to implement two-level control with control qubits c₁, c₂, then one uses the two-qubit controlled Z gate CZ_{c}_{_{1,}}_{c}_{₂} on these qubits as the requisite unitary gate G_{c}_{_{1,}}_{c}_{₂}.

Any number of control levels can be implemented in this fashion.

In many of the disclosed embodiments, variational circuits are comprised (and, in some cases, solely) from the single-cubit and two-qubit gates. However the above discussion explains how these designs can be readily generalized (if needed) to involve more sophisticated multi-cubits unitaries.

### D. Ancilla-Free and Ancilla-Assisted Approximate Amplitude Encoding

Let χ=be [χ₁, . . . , χ_{N}] some classically defined vector in [symbol] ^{N}. Assume, for simplicity, that N=2ⁿ where n is some integer. An quantum amplitude encoding of χ is a quantum state |χ [symbol] such that the probability of measuring some |j [symbol] , j∈[N] in this state is χⱼ²/|χ|². The task of a desirable amplitude encoding given χ is the task of finding such quantum circuit C_{χ} that constructs a quantum amplitude encoding of χ from some non-informative “free” state, for example C_{χ}|0 [symbol] =|χζ.

It is known that for vector χ in a general position, a desirable encoder circuit C_{χ} will contain Ω(N) single- and two-qubit gates. Since in an interesting machine learning training loop, encoder circuits for the classical data samples will be invoked millions, if not billions of times, it makes sense to, in some embodiments, preprocess the classical samples once and associate the shortest possible amplitude encoder circuit with each data, sample. Due to the above-mentioned asymptotic lower bound in Ω(N), there is a limit on how much an encoder circuit can be compressed. Since the data in a machine learning problem is almost always inherently noisy and since the inference in such problems is almost never expected to be perfect, it makes sense to look for resource-optimal approximate quantum encoders for classical data.

For example, suppose f>>0 is the desired fidelity of an approximate encoding. If C_{χ} is an n-qubit exact encoder for χ, C_{χ}|0 [symbol] =|χ [symbol] and if \tilde{C}_{χ} is an inexact encoder than the fidelity goal can be written as

[symbol]

[symbol]

C_{χ}0|\tilde{C}_{χ}0 [symbol] >f

Assuming, again that dim χ=N=2ⁿ and both circuits C and \tilde{C} are n-qubit circuits, one can frame the task of approximate quantum encoding as the task of finding a variational quantum circuit \tilde{C} that approximates the known fixed unitary operator C on a one-sample reference set S₀={[1, 0, . . . , 0]}. In this setting, the problem of finding a desirable (e.g., optimal) \tilde{C} is a special case of an operator approximation problem that has been solved in section IIIB.

In many cases, however, the desired approximate encoder circuit \tilde{C} can be made quadratically shorter if one were allowed to use clean ancillary qubits.

In some embodiments, for instance, suppose one added m clean ancillary qubits to the register and the goal now is to approximately emulate the fixed n-qubit unitary operator C_{χ} using a circuit \tilde{C}on the full register of n+m qubits. The emulation task can be defined as the task of approximating some product state |χ [symbol] ⊗|α [symbol] where |α [symbol] is an arbitrary m-qubit ancillary state. In case one wanted to represent the desired encoding |χ [symbol] exactly, then one would have (C_{χ}^{†}⊗I^{m})\tilde{C}|0 [symbol] ^{⊗(n+m)}=|0 [symbol] ^{⊗n}⊗|α [symbol] . Thus, the exact encoding the state (C_{χ}^{†}⊗I^{m})\tilde{C}|0 [symbol] ^{⊗(n+m)} lies entirely the 2^{m} dimensional subspace [symbol] _{α} spanned by the states of the from |0 [symbol] ^{⊗n}⊗|α [symbol] . In the approximate encoding setting one wants the overlap of the (C_{χ}^{†}⊗I^{m})\tilde{C}|0 [symbol] ^{⊗(n+m)} with the subspace [symbol] _{α} to be as close to 1 as possible.

Let Π_{α} be the orthogonal projector of the full 2^{n+m}-dimensional state space on the sub-space [symbol] _{α}. Let f be some fidelity threshold that is asymptotically close to 1. Then ultimately the approximate emulator circuit \tilde{C} at fidelity f can be defined as a one satisfying the condition

∥Π_{α}(C_{χ}^{†}⊗I^{m})C\tilde{C}|0)^{⊗(n+m)}∥²>f

In order to derive an embeddable unitary version of this condition consider the n-qubit reflection operator [symbol] that flips the amplitude sign of the single basis state |0 [symbol] ^{⊗n} (naturally, [symbol] is an adjoint of the (n−1)-time controlled Pauli Z). Then Π_{α}=½(Iₙ₊ₘ− [symbol] ⊗I^{m}), ∥Π_{α}(C_{χ}⁵⁵⁴⊗I^{m})\tilde{C}|0 [symbol] ^{⊗(n+m)}∥²≤½(1− [symbol] [symbol] (C_{χ}⁵⁵⁴⊗I^{m})\tilde{C}|0 [symbol] ^{(n+m)}|(R_{|0} [symbol] ⊗I^{m}) (C_{χ}⁵⁵⁴ ⊗I^{m})\tilde{C}|0 [symbol] ^{⊗(n+m)} [symbol] ) and the task of approximating to fidelity f can be reinterpreted as task of minimizing [symbol] [symbol] (C_{χ}^{†}⊗I^{m})\tilde{C}|0 [symbol] ^{⊗(n+m)}|R_{|0} [symbol] ⊗I^{m}(C_{χ}^{†}⊗I^{m})\tilde{C}|0 [symbol] ^{⊗(n+m)} [symbol] so that

[symbol]

[symbol]

(C_{χ}^{†}⊗I^{m})\tilde{C}|0 [symbol] ^{⊗(n+m)}|(R_{|0} [symbol] ⊗I^{m})(C_{χ}^{†}⊗I^{m})\tilde{C}|0 [symbol] ^{⊗(n+m)} [symbol] 1−2f (12)

If one can choose a trainable template for the desired \tilde{C} according to the ansatz (1) then (12) can be solved with the tools developed in section IIIC with the stipulation that the sample set now consists of the single “sample” |0 [symbol] ^{⊗(n+m)}.

In practice, the ancilla count m=2 is almost always sufficient for quadratic compression of an approximate state encoder, compared to ancilla-free approximations of the same encoder.

### IV. Training Algorithm

Embodiments of the disclosed technology are not dependant on learning rate scheduling and do not require asymptotically significant number of epochs to converge.

However, since embodiments of the disclosed variational circuit learning technique prove (e.g., optimize) essentially the same utility function with the same optimization landscape, the technique may not provide a different principled resolution to the problem of finding the global optimum. (The problem of global optimization over non-convex landscapes is, in general, NP hard.) Therefore, it is desirable to explore the global utility function landscape either by adhoc sampling in the parameter space or by more sophisticated strategies, such as simulated annealing or Bayesian inference.

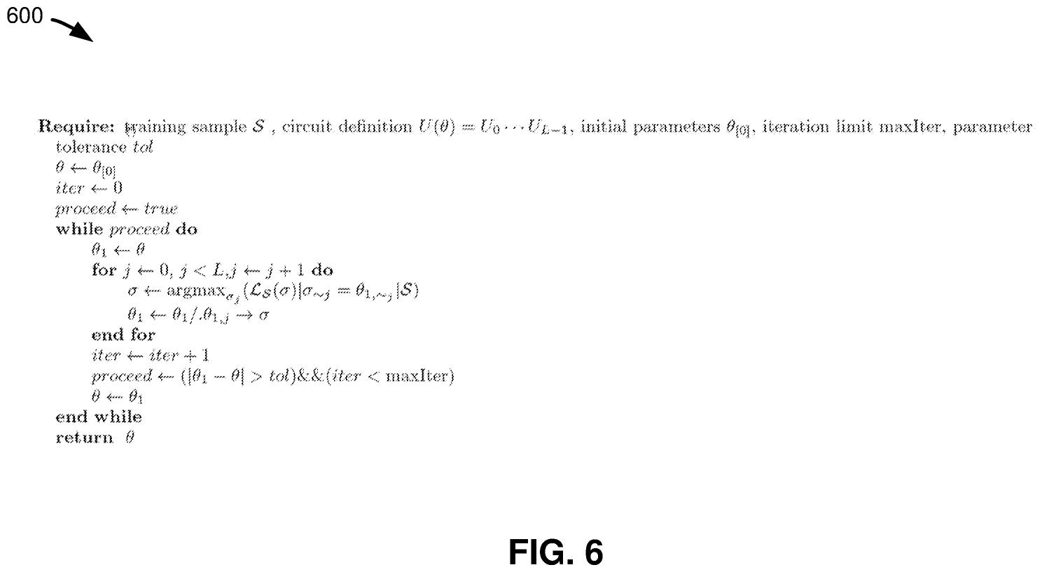

Here, one can start with the subalgorithm that obtains an approximation of some local maximum of the utility function that is, in some sense, close to a given starting point in the parameter space. The pseudo-code for the algorithm is shown in FIG. 6. In particular, FIG. 6 shows a subalgorithm for coordinate ascent from an initial parameter setting.

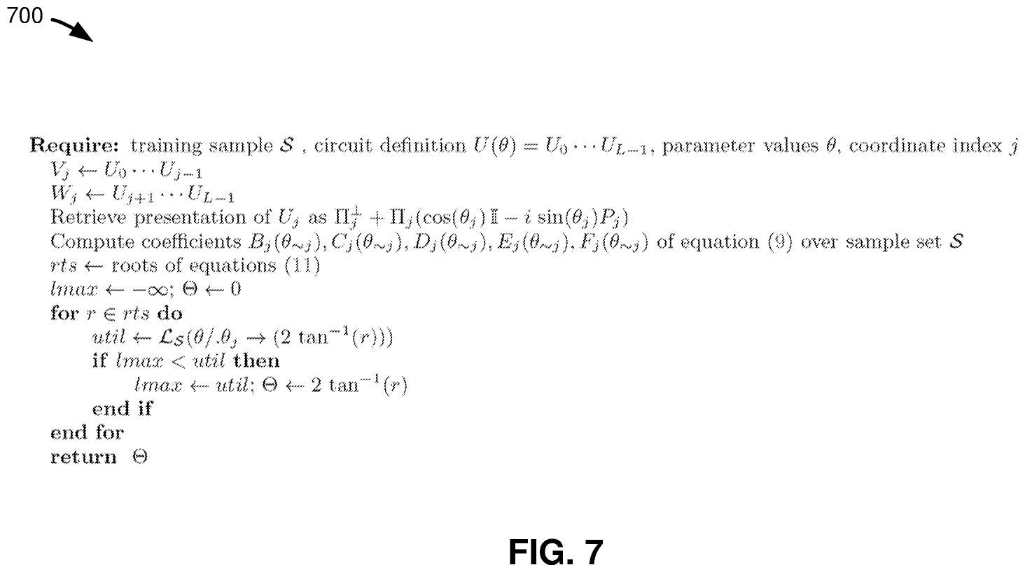

The argmax_{σ}_{ⱼ}( [symbol] _{S}(σ)) is computed using mathematics developed in section IIIC. In FIG. 7, this computation is in the form of pseudo-code. In particular, FIG. 7 at 700 shows pseudo-code for a subalgorithm for maximizing along an individual parameter.

### V. Algorithm Complexity

In order to compare the coordinate ascent algorithm to other algorithms, one can measure performance in terms of quantum overlap values computed. Given a measurable observable A and some small tolerance value δ>0 the computation unit that is referred to as a quantum overlap unit is the task of computing ether [symbol] [symbol] χ|A|y [symbol] or [symbol] [symbol] χ|A|y [symbol] , where quantum states χ and y can be prepared at some constant cost cₚᵣₑₚ. (The preparation cost will be roughly the same for all the data samples involved in estimating the quantum utility function [symbol] (θ).)

Given the circuits C_{χ}, C_{y} to prepare quantum encodings of the two data samples, |χ [symbol] =C_{χ}|0 [symbol] , |y [symbol] =|0 [symbol] , then either [symbol] or [symbol] of the overlap can be estimated by estimating [symbol] 0|C_{χ}AC_{y}^{†}|0 [symbol] to required precision a using one ancillary quint and a version of Hadamard test. In this context, the cost of an instance of the Hadamard test is fixed and it is desirable to use O(1/δ²) instances of the test to estimate either the real or imaginary part of the overlap.

In some embodiments, for a selected parameter index j∈[0. . . (L−1)], the corresponding coefficients are Bⱼ, Cⱼ, Dⱼ, Eⱼ, Fⱼ that inform equations (9). And (10) are aggregated over the entire sample set S₁ and thus the overall cost of generating these coefficients is in O( [symbol] /δ²). It is noted that the values of the coefficients Bⱼ, Cⱼ, Dⱼ, Eⱼ, Fⱼ can be collected independently given a sufficient width of the quantum register. Further parallelization is possible by computing the constituent overlaps simultaneously. (For example [symbol] [symbol] VⱼWⱼχ|A|VⱼWⱼχ [symbol] [symbol] [symbol] VⱼGWⱼχ|A|VⱼGWⱼχ [symbol] and [symbol] (μ₁ [symbol] VⱼWⱼχ|A|VⱼGWⱼχ [symbol] that inform the coefficient dⱼ can be computed simultaneously.) Possible shortage of qubits for complete parallelization affects only the constant of the complexity term O(| [symbol] |/δ²), but not the shape of this term.

In a typical scenario, each of the trainable parameters is visited at least once. The cost of one complete iteration over the parameter set is thus in O(L| [symbol] |/δ²). Maximation with respect to several parameters is strongly related to commutation relations between the constituent quantum gates.

Consider the task of estimating a local optimum of the utility function to a precision δ by coordinate ascent starting at some initial guess θ_{[0]}. This task will be referred to as a sprite(θ_{[0]}, δ). It is currently understood that for a θ_{[0]} in general position the sprite(θ_{[0]}, δ) requires an iteration count limit maxIter in O(log(1/δ)). The numerical simulations corroborate this understanding. With this understanding, the overall cost of exploring one local maximum of the utility is in O(L| [symbol] |log(1/δ)/δ²) when measured as a total count of the required number of the instances of Hadamard test.

It is notable that the sequence of improvements of the utility function under coordinate ascent is almost strictly monotonic. Ideally, if all the quantum gates and measurement are completely precise and if all the required state overlaps are computed with infinite precision, then the utility function can never decrease upon a coordinate update. In practice due to accumulated imprecision, the utility function can occasionally experience small regressions by some amount in O(δ). In practice such regressions are observed infrequently.

Embodiments of the disclosed technology present one or more advantages over other techniques. For example:

First, in other approaches, convergence can be sensitive to the choice of learning rate. Poor choices of learning rates or learning schedules can lead to a non-converging process. But, given that when a convergence is established, the precision of the achieved proxy to a local minimum depends strongly on the learning rate strategy. Therefore, to achieve a sufficient precision one typically needs to perform sweeps and model selection over significant (often, rather large) numbers of candidate learning rate strategies.

Second, some other approaches suffer from a pathology known as a “vanishing gradient”. This happens at parameter configurations where the cost function forms saddle points or “barren plateaus’. There are often no succinct criteria to distinguish true local minima from temporary gridlocks caused by vanishing gradients. This may lead to practical obstacles for reaching global minimum in otherwise common scenarios. Coordinate methods are much less susceptible to problems of this kind.

### VI. Numerical Experiments

### A. Further Example Implementations

### i. Approximate State Preparation

Suppose the dimensionality of feature vectors that represent classical data samples is N˜2ⁿ. The information-theoretical lower bound for the number of parameters required for preparing a faithful amplitude encoding of a random N-dimensional vector is N. However, meaningful data vectors seldom have maximum entropy. It should be understood that the number of parameterized quantum gates required for preparing a high-fidelity encoding of a classical vector scales with O(entropy*log(N)) assuming constant number of available ancillary quoits.

A motivation for this understanding is given by the following:

Proposition 2. Let n be the desired qubit count. Given a k-sparse vector in [symbol] ²ⁿ (e.g., a real-valued vector with k non-zero elements), an n-qubit quantum amplitude encoding of this vector can be prepared by a quantum circuit with O(k n) single and two-qubit quantum gates using a quantum register with at most (n+2) (i.e., assuming at most two additional ancillary qubits).
Proof. Recall that a two-level R_{Y} rotation [symbol] (θ) rotates the span(|j [symbol] , | [symbol] [symbol] ) as follows: |j [symbol] [symbol] cos(θ/2)|j [symbol] +sin(θ/2)| [symbol] ; | [symbol] [symbol] [symbol] −sin(θ/2)|j+cos(θ/2)| [symbol] ). It leaves the orthogonal complement of the span(|j [symbol] , | [symbol] ) stationary.

It is obvious that a quantum encoding of a k-sparse vector can be prepared starting from |0 [symbol] [symbol] 0| by consecutive use of at most k two-level R_{Y} rotations.

It is now desirable to estimate the cost of the [symbol] (θ) for an angle θ in general position. Because an asymptotic argument is being made, one can take n>5 in order to use a lemma from A. Barenco and et al., Phys. Rev. A 52, 3457 (1995). Since R_{Y} (θ)=S H R_{Z}(θ) H S^{†}, the cost of [symbol] (θ) is asymptotically the same as that of [symbol] (θ). The latter is however an (n−1) times multiplexed single-qubit diagonal unitary R_{Z}(θ). It is well known that with one clean ancillary qubit the latter can be emulated with two single qubit R_{Z} rotations and three n-times multiplexed X gates using an (n+1)-qubit quantum register. With one additional ancillary qubit each of these ((n+2)−2) times multiplexed X gates can be emulated using O(n) 3-qubit Toffoli gates. Since a 3-qubit Toffoli gate has an exact representation of constant depth and size, the understanding as described above follows.

While it can be shown that Θ(k n) is asymptotically optimal gate cost of quantum encoding for k-sparse vectors, a question of practical importance for quantum machine learning is developing a methods for the best effective approximate state preparation. The goal here can be described as that of finding efficiently computable constant cₚᵣₑₚ such that for small positive δ>0 a δ-approximation of the desired encoding of a k-sparse vector can be prepared using a a circuit with at most cₚᵣₑₚk n log₂(1/δ) single and two-qubit rotation gates.

One can do this using methods developed in section IIID.

### VII. Example Embodiments

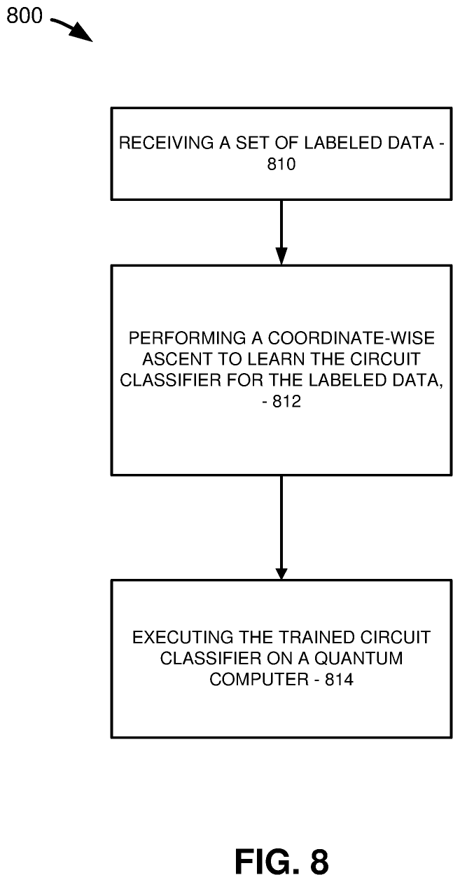

FIG. 8 is a flow chart 800 illustrating a method in accordance with the disclosed technology. The particular operations and sequence of operations should not be construed as limiting, as they can be performed alone or in any combination, subcombination, and/or sequence with one another. Additionally, the illustrated operations can be performed together with one or more other operations.

In FIG. 8, a circuit classifier is trained based on variational quantum circuits. In the illustrated embodiment, and at 810, a set of labeled data is received (e.g., by a classical computer); at 812, a coordinate-wise ascent is performed to learn the circuit classifier for the labeled data. In some examples, the coordinate-wise ascent is performed on a classical computing device which thereby trains the circuit classifier. At 814, the trained circuit classifier is executed on a quantum computer. In some implementations, the circuit classifier has a structure with variational parameters. The circuit classifier can comprise a plurality of single-qubit and/or two-qubit gates that have variational parameters defining unitary action of the circuit on quantum states. In some examples, the training further comprises modifying all but one of the variational parameters. In further examples, the training comprises maximizing a utility function by selection of one or more variational parameters. The utility function can, for example, apply a non-degenerate observable that has exactly two different eigenvalues. In some examples, the variational parameters are fixed one by one, according to a predetermined schedule that visits each parameters at least once. In other examples, the variational parameters are fixed one by one, according to a randomized schedule that visits each parameters at least once. In some examples, the training comprises splitting the training data into smaller batches that are used by the utility function to update the variational quantum circuits.

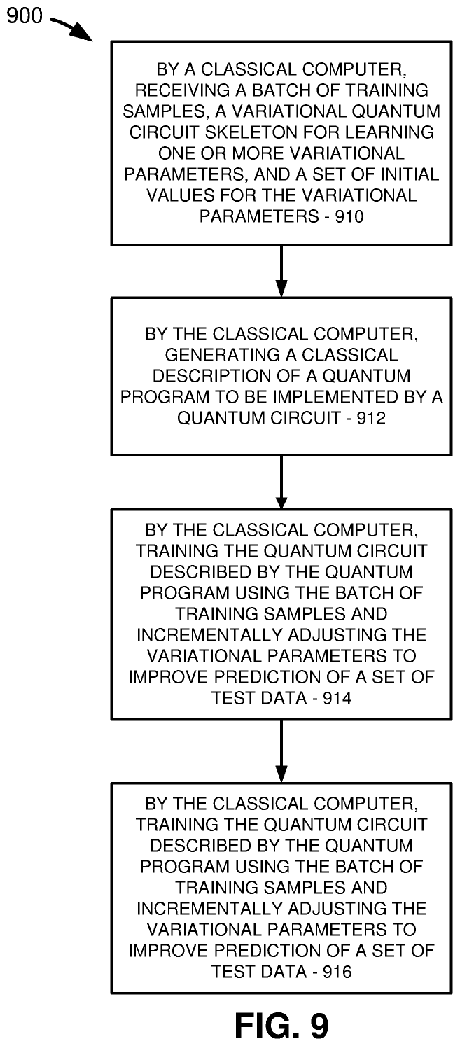

FIG. 9 is a flow chart 900 illustrating a further method in accordance with the disclosed technology. The particular operations and sequence of operations should not be construed as limiting, as they can be performed alone or in any combination, subcombination, and/or sequence with one another. Additionally, the illustrated operations can be performed together with one or more other operations.

In FIG. 9, and at 910, by a classical computer, a batch of training samples, a variational quantum circuit skeleton for learning one or more variational parameters, and a set of initial values for the variational parameters are received. At 912, and by the classical computer, a classical description of a quantum program is generated to be implemented by a quantum circuit. At 914, and by the classical computer, the quantum circuit described by the quantum program is trained using the batch of training samples and incrementally adjusting the variational parameters to improve prediction of a set of test data. At 916, the trained quantum circuit described by the quantum program is implemented on a quantum computing device.

In some examples, the method further comprises receiving one or more of parameter tolerance bounds, and/or a bound on a maximum number of iterations to be performed during the training. In some implementations, the training is performed iteratively by computing analytic expressions for expectation values of the training data to increase a probability of correct identification of training labels. In some implementations, the expectation value is inferred by computing overlaps between quantum states. For example, the overlap computation can be performed by a Hadamard test to infer the real and imaginary components of the overlap. In further examples, the training sample is given by a qubit encoding or an amplitude encoding in which data is represented as amplitudes or phases of a state vector of qubits of the quantum circuit.

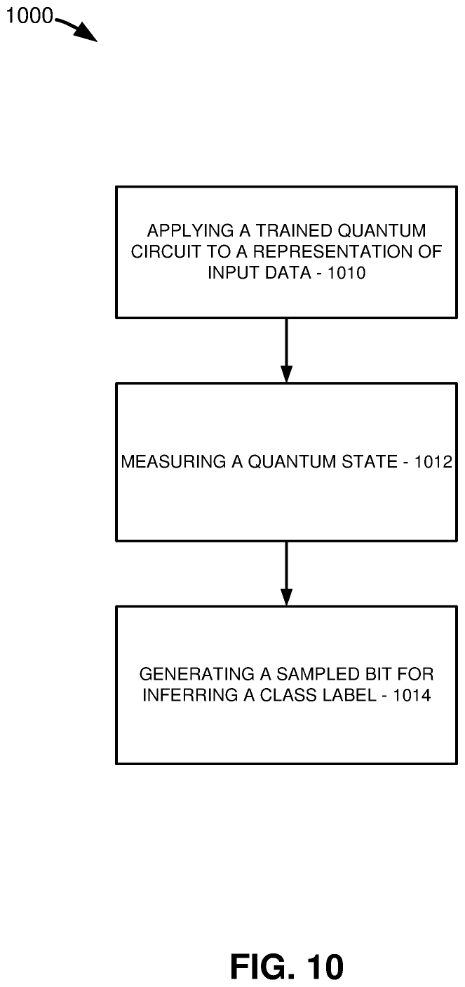

FIG. 10 is a flow chart 1000 illustrating a further method in accordance with the disclosed technology. The particular operations and sequence of operations should not be construed as limiting, they can be performed alone or in any combination, subcombination, and/or sequence with one another. Additionally, the illustrated operations can be performed together with one or more other operations.

The method of FIG. 10 can be performed, for example, by a system comprising a quantum computing device and a classical computing device in communication with the quantum computing device. In the illustrated method, and at 1010, a trained quantum circuit is applied to a representation of input data. At 1012, the quantum state is measured. At 1014, a sampled bit for inferring the class label is generated.

In certain implementations, the representation of the input data is given by an amplitude encoding of the data or a qubit encoding of the data. In further implementations, the classical computing device is programmed to train the quantum computer to predict a class label using a pre-trained classifier circuit. In further implementations, the coordinate ascent procedure uses hyperparameters. In some implementations, the set of hyperparameters includes one or more of: (a) a depth of the quantum circuit that is being trained: (b) a size of a mini-batch in training the quantum circuit; (c) a maximum number of iterations used for training; (d) number of random restarts that are applied un the training. In certain implementations, a program run on a classical computer is used for sweeping through feasible values of hyperparameters and and post-selecting quantum circuit(s) with the optimal hyperparameter choices.

### VIII. Concluding Remarks

Having described and illustrated the principles of the disclosed technology with reference to the illustrated embodiments, it will be recognized that the illustrated embodiments can be modified in arrangement and detail without departing from such principles. For instance, elements of the illustrated embodiments shown in software may be implemented hardware and vice-versa. Also, the technologies from any example can be combined with the technologies described in any one or more of the other examples. For example, alternative embodiments can use a stochastic gradient descent approach that converges to a local minima. It will be appreciated that procedures and functions such as those described with reference to the illustrated examples can be implemented in a single hardware or software module, or separate modules can be provided. The particular arrangements above are provided for convenient illustration, and other arrangements can be used.

1. A method comprising:
training a circuit classifier based on variational quantum circuits, wherein the training comprises receiving a set of labeled data and performing a coordinate-wise ascent to learn the circuit classifier for the labeled data, wherein the coordinate-wise ascent is performed on a classical computing device and thereby trains the circuit classifier; and
executing the trained circuit classifier on a quantum computer.

2. The method of claim 1, wherein the circuit classifier has a structure with variational parameters.

3. The method of claim 2, wherein the circuit classifier comprises a plurality of single-qubit and/or two-qubit gates that have variational parameters defining unitary action of the circuit on quantum states.

4. The method of claim 2, further comprising modifying all but one of the variational parameters.

5. The method of claim 2, maximizing utility function by selection of one or more variational parameters.

6. The method of claim 5, wherein the utility function applies a non-degenerate observable that has exactly two different eigenvalues.

7. The method of claim 2, wherein the variational parameters are fixed one by one, according to a predetermined schedule that visits each parameters at least once.

8. The method of claim 2, wherein the variational parameters are fixed one by one, according to a randomized schedule that visits each parameters at least once.

9. The method of claim 2, wherein the training comprises splitting the training data into smaller batches that are used by the utility function to update the variational quantum circuits.

10. A computer-implemented method, comprising:
receiving a plurality of training samples, a variational quantum circuit skeleton for learning one or more variational parameters, and a set of initial values for the variational parameters;
by a classical computer, generating a classical description of a quantum program to be implemented by a quantum circuit;
by the classical computer, training the quantum circuit described by the quantum program using the plurality of training samples and incrementally adjusting the variational parameters to improve prediction of a set of test data; and
implementing the trained quantum circuit described by the quantum program on a quantum computing device.

11. The computer-implemented method of claim 10, wherein the receiving further comprises receiving one or more of parameter tolerance bounds, and/or a bound on a maximum number of iterations to be performed during the training.

12. The computer-implemented method of claim 10, wherein the training is performed iteratively by computing analytic expressions for expectation values of the training data to increase a probability of correct identification of training labels.

13. The computer-implemented method of claim 12, wherein the expectation value is inferred by computing overlaps between quantum states.

14. The computer-implemented method of claim 13, wherein the overlap computation is performed by the Hadamard test to infer the real and imaginary components of the overlap.

15. The computer-implemented method of claim 14, wherein the training sample is given by a qubit encoding or an amplitude encoding in which data is represented as amplitudes or phases of a state vector of qubits of the quantum circuit.

16. A system, comprising:
a quantum computing device; and
a classical computing device in communication with the quantum computing device, the classical computing device being programmed to predict a class label using a quantum computer that applies a trained quantum circuit to a representation of the input data, measures the quantum state, and generates a sampled bit for inferring the class label.

17. The system of claim 16, wherein the representation of the input data is given by an amplitude encoding of the data or a qubit encoding of the data.

18. The system of claim 16, wherein the classical computing device is programmed to train the quantum computer to predict class label using pre-trained classifier circuit.

19. The system of claim 18, wherein the coordinate ascent procedure uses hyperparameters.

20. The system of claim 19, wherein the set of hyperparameters includes one or more of: (a) a depth of the quantum circuit that is being trained; (b) a size of a mini-batch in training the quantum circuit; (c) a maximum number of iterations used for training; (d) a number of random restarts that are applied in the training.
